(19) United States
(12) Patent Application Publication
(10) Pub. No.: US 2012/0021499 A1
(43) Pub. Date: Jan. 26, 2012

(54) Method for removing pollutants in pollutants-contaminated soil

(75) Inventor: Chi-Tsan Lin, Kaohsiung City (TW)

(73) Assignee: Chi-Tsan LIN

(21) Appl. No.: 12/929,421

(22) Filed: Jan. 24, 2011

(30) Foreign Application Priority Data
Jul. 22, 2010 (TW) 99124200

(51) Int. Cl. A62D 3/02

(52) U.S. Cl. 435/262.5

(57) ABSTRACT

A method for removing pollutants in pollutants-contaminated soil is disclosed. The method includes following steps. A biodiversity system with microbial biodiversity characterization is used to induce growth and reproduce of at least one dominant synergistic flora for petroleum degradation. Most of the petroleum in the soil can be degraded when the temperature of the biodiversity system is below 30-50° C. The remained petroleum in the soil is than rapidly washed out from the soil through forming a petroleum-in-water emulsion by biosurfactant synthesized by the microorganisms in the biodiversity system.

### RELATED APPLICATIONS

This application claims priority to Taiwan Application Serial Number 99124200, filed Jul. 22, 2010, which is herein incorporated by reference

### BACKGROUND

1. Field of Invention

The present disclosure relates to a treatment for soil pollution. More particularly, the present invention relates to a treatment for a rapid treatment on the oil pollutants-contaminated soil.

2. Description of Related Art

Due to the large consumption of petroleum products currently, frequent storage and transport have been causing environmental pollutions. General remediation of oil pollutants-contaminated soil technology includes physical treatments, chemical treatments and biological treatments. Trend of biological treatment plays an important role of the main stream today.

So far, there has been developed technology of microbial degradation of oil pollution, including using screened and cultivated oil degrading bacteria in the oil-contaminated sites with adding additives to treat the oil-contaminated soil.

Studies have shown Bacillus sp. and Pseudomonas sp. are suitable for 20˜44° C. temperature range to degrade low carbon number crude oil (Antai, 1990).

Diesel can be degraded in medium with nutrition by oil degrading bacteria screened from the crude oil-contaminated sites, such as Pseudomonas alcaligenes, Ochrobactrum intemedium, Sphingobacterium sp., Pseudomonas putida, Klebsiella oxytoca, Chryseobacterium sp., Stenotrophomona maltophilia can be added with nutrients in the medium to degrade diesel (Owsianiak et al., 2009).

90% of fuel oil in the fuel oil-contaminated marine sediment can be degrade by incorporating E coli and Pseudomonas maltophilia with soap water within 35 days (Hua, 2006).

Based on the above, we can be informed that most of the current bio-remediation technologies are artificially added oil degrading bacteria or reagents, and rely on the engineering practices to add inorganic microbial nutrients (nitrogen, phosphorus) to rapidly create a favorable environment for microbial growth and reproduction to successfully degrade oil; and regardless of types of approaches, considerations are all applied to cost, acceptable clean up criteria, degradation efficiency, time of restoration, technical engineering barriers and other issues.

However, artificially added oil degrading bacteria so far is often not suitable for the in-situ field environment, and can not achieve the desired removal performance, or remediation results, progress and quality can not be ensured. Moreover, relying on the engineering technology to add the inorganic microbial nutrients is often subject to engineering controls, thus application efficiency of microbial is not sufficient.

Therefore, how to use the shortest time frame, the minimum cost and the most effective way to achieve the purpose of decontamination is the biggest challenge of oil-contaminated soil bioremediation technologies

### SUMMARY

A method for removing pollutants in pollutants-contaminated soil is provided. The method comprises following steps.

A biodiversity system with microbial biodiversity characterization is provided. The biodiversity system includes a key matrix, and a microorganism community with microbial biodiversity characterization. The key matrix containing 60-70% by weight of a compostable mixture and 30-40% by weight of a petroleum hydrocarbons-contained soil, where the compostable mixture containing 0.5-10% by weight of fatty acid, and the compostable mixture having a C/N ratio of 10-20. The key matrix can be metabolized by microorganisms lived in the biodiversity system. The microorganism community metabolizes the key matrix and at least one dominant synergistic flora is induced by the key matrix at 50-75° C. to degrade the petroleum hydrocarbons contained in the biodiversity system. The dominant synergistic flora further synthesizes at least one biosurfactant in nutrition metabolization.

Water is added into the biodiversity system when the temperature of the biodiversity system is decreased at 35-50° C. to form a petroleum-in-water emulsion and the remained petroleum hydrocarbons from the soil is separated to reduce the amount of the petroleum hydrocarbons to 1,000 mg/Kg or less.

In accordance with one or more embodiments of the present disclosure, the petroleum hydrocarbons-contained soil containing petroleum hydrocarbons with 6 to 40 carbon atoms chain, and the total petroleum hydrocarbons content is at least 1,000-50,000 mg/Kg.

In accordance with one or more embodiments of the present disclosure, the fatty acid is CₙH₂ₙ₊₁COOH, CₘH₂ₘ₋ₓCOOH, CnH₂ₙ₊₁OH, or any combination to thereof, wherein n=2-20, m=16-40, X is 1, 3, 5, 7, or any combination thereof.

In accordance with one or more embodiments of the present disclosure, the compostable mixture is cooked food wastes, or edible oil/fat-contained food wastes.

In accordance with one or more embodiments of the present disclosure, when the biodiversity system temperature is down to about 35-40° C., most of the petroleum hydrocarbons have been degraded and total petroleum hydrocarbons compared to the initial content can be reduced by above 80%.

It is to be understood that both the foregoing general description and the following detailed description are by examples, and are intended to provide further explanation of the invention as claimed.

### BRIEF DESCRIPTION OF THE DRAWINGS

FIG. 1 is a chart shows the relationship between the temperature changes and the treatment days of various initial total petroleum hydrocarbons (TPH) dry basis concentration in the system.

FIG. 2 is a chart shows the relationship between the temperature changes and the treatment days of various ratios between organic materials of key matrix and soil trials.

FIG. 3 is a chart shows the trial temperature and TPH concentration trends when degrading petroleum hydrocarbons in soil in a large scale trial with the presented invention of biodiversity system characteristics.

FIG. 4 is a flow chart shows the steps to deal with pollutants-contaminated soil.

### DETAILED DESCRIPTION

is In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

According to one or more embodiments of the disclosure, rapid treatment for soil pollution consists of two main phases: (1) use of a biodiversity system with microbial biodiversity characterization to degrade a large number of petroleum contaminants in the soil; and (2) use biosurfactants produced by the system to emulsify the petroleum remained from degradation can achieve rapid separation to remove petroleum in the soil.

As described in the present disclosure “biodiversity system with microbial biodiversity characterization”, refers to the interaction between the biological system (it indicates specifically to microorganism) and non-biological system (it indicates environmental factors for the supply of microbial growth) represents the highly complex dynamic balance. The system consists of relatively stable space environment, nutrient, air, water, other environmental factors, bacteria and colony volume in the beginning; however, it is gradually limited to bacteria and limited environmental factors which increase the consumption of air, water and nutrient and results in the energy transmission and the change of environmental temperature. In another situation, microorganisms generate the genetic variation or functional adaptation (e.g. domestication) from the above mention environmental variation process. During the process, it can be formed more than one balance environment and microflora which are different from the beginning and have been lasting for a period of time respectively, or have multiple existences simultaneously.

The abilities of the described bacteria “to degrade total petroleum hydrocarbons in the soil” include (1) to degrade relatively long chain petroleum hydrocarbons into relatively short chain compounds, and (2) to metabolize petroleum hydrocarbons into fatty acids, esters, alcohols, aldehydes or other carbon sources.

According to one or more embodiments of the present disclosure, the majority of microbial degradation of petroleum hydrocarbons in the soil was provided by the biodiversity of the characteristic system. The characteristics of this system include bacterial community with microbial biodiversity and the key matrix for microbial metabolism.

According to one or more embodiments of the presented disclosure, the key matrix contains 60-70% by weight of compostable mixture and 30-40% by weight of petroleum hydrocarbons-contaminated soil.

The compostable mixture in the key matrix particularly contains fatty acids which are with 0.5-10% by weight and 10-20 carbon/nitrogen ratio (C/N ration) of organic material. In addition, compostable mixture can further contain carbohydrates, nitrogen compounds, ash and so on.

In accordance with one or more embodiments of the presented disclosure, the fatty acids can be CₙH₂ₙ₊₁COOH, CₘH₂ₘ₋ₓCOOH, CnH₂ₙ₊₁OH, or any combination thereof, where n=2-20, m=16-40, X is 1, 3, 5, 7, or any combination thereof. Carbohydrates can be polymer of Cₙ(H₂O)ₙ₋₁, [CH₂O)ₙ]ₓ, (C₆H₁₀O₅), polymer of C₁₂H₂₂O₁₀, or any combination thereof, where n=3-7, X=1-10. General formula for nitrogen compounds can be R—CH₂—CH—NH₂—COOH, where R is —H, —CₙH₂ₙ₊₁ and n=1,2,3 or 4 integers, —C—[C₆H₅], —C—[C₆H₄]—OH, —C-[indole], —C-[imidazole], —CₙH₂ₙ₊₁COOH and n=1 or 2 integers, R′—NH₂ and R′ is —C₄H₉ or —COCH₂′—C₃H₇-[guanidine] ′—CH₂OH′—C(OH)—C′—C₂H₅—S—CH₃′—CH₂SH C—S—S—C′ imino acid, or any combination of the above. Ash can be sodium chloride, potassium iodate, potassium chloride, calcium carbonate, magnesium carbonate, or any combination thereof.

The petroleum hydrocarbons contaminated soil of key matrix contains petroleum hydrocarbons with 6 to 40 carbon atoms chain, and the total petroleum hydrocarbons content is at least 1,000-50,000 mg/Kg. The term “Key” of the “Key matrix” described in the present disclosure means to promote the system through the microbial population evolution of the same or different directions resulting in relatively consistent features. The growth and decline of the specific composition of the key matrix can affect the survival of microbial community in the system. In the system, one or more bacteria have traits related to the key matrix may produce an environmental change, or evolve new bacteria strain for adapting to the key matrix.

The flora with microbial biodiversity characterization can metabolize the key matrix as nutrient and produce at least one biosurfactant. In accordance with one or more embodiment of the present disclosure, biosurfactants are humic substances, glycolipids, phospholipids, or any combination thereof.

The “microbial biodiversity characterization” described in the present disclosure means that there is not only one single microbial genetic background or one specific and consistent microbial function (especially associated with petroleum hydrocarbons degraded function) bacterial community. The system includes bacterial community that originally in the environment (air, water, soil, the key matrix) is with two or more the same or different microbial genetic backgrounds or two or more specific and consistent microbial functions, the same or different bacteria at different growth phases at the same time, differentiation between the same bacteria caused by environmental factors to increase kinds of bacteria, the original bacteria existing in the environment adapt to environment causing genetic variations to arise out one or more than one kinds of bacteria, the environmental factors to produce predominated bacteria strains and bacterial community to affect growth or decline of bacteria and strain, and one or more of the above phenomenon.

The embodiments of presented disclosure use the microbial biodiversity system with key matrix as the growth environment to induce a synergistic flora that predominated growth at 50-75° C. and produce petroleum hydrocarbons degradation ability.

Term “induced” refers to bacteria through the interaction with environmental factors in the system, especially with the key matrix, follow the basic metabolic pathway or induced particular metabolic pathway deliver certain functions and products.

Term “synergistic flora” means at least two or more different genus, species or strain of bacteria, can work together at 50-75° C. temperature at the same or different growth phases using the same or different metabolic mechanisms, or produce the same or different metabolites to have the same or different petroleum hydrocarbons degraded compounds.

In accordance with one or more embodiment of the present disclosure, synergistic flora can include but are not limited to Bacillus sp., Bacteroidetes bacterium, Brevibacillus borstelensis, Pseudoxanthomonas sp., Shigella flexneri, Ureibacillus sp., Cellulosimicrobium sp., Escherichia coli, Methylobacterium polarium, Proteus mirabilis, Bacillus licheniformis, Low G+C Gram-positive bacterium (Guanin), Cytosine content Gram positive bacteria and any combination thereof.

It should be noted that, as described in the present disclosure, “the ability to degrade petroleum hydrocarbons” is not limited to the above synergistic flora, the disclosure features a system of biodiversity in other bacterial community, may also have ability to metabolize the relatively short chain compounds, fatty acids, esters, alcohols, aldehydes to promote degrading of total petroleum hydrocarbons in the soil.

According to above, the embodiments of the presented disclosure apply the interaction between microbial genes and environmental factors in degrading petroleum hydrocarbons in the soil. During the interaction process between bacteria and environmental factors, in order to reproduce and maintain balance of the system, bacteria choose the most effective metabolism to transfer energy. Through evolution of bacteria, functions developed to use the key matrix, namely, the ability to degrade petroleum hydrocarbons, or a tendency to produce the predominated microflora that can be adapted to the key matrix environment.

The key factor of reproductive function in the biodiversity system is the special component and composition ratio of the key matrix. It can be evolved or produced the dominant synergistic flora under the high temperature and originate the function for synergistically degrading petroleum hydrocarbons from the high temperature range of 50-75° C. The synergistic effect includes degrading relatively long-chain petroleum hydrocarbons into relatively short-chain composition, or metabolizes fat acid, ester, alcohols, aldehydes, or carbon for microbial species and cause the result of reducing the total petroleum hydrocarbons in the soil.

In accordance with one or more embodiments of the present disclosure, when the synergistic flora grow at 50-75° C., the frequency of aeration is every 18-30 hours and maintain system moisture of 35-55 wt % to keep the synergistic flora maintaining the predomination growth.

Later, when system temperature is down to about 35-40° C., the role of bacterial degradation of petroleum hydrocarbons has been greatly driven slow. When it happens, can use water mixing with the residual petroleum hydrocarbons contaminated materials in the system (mixing ratio can be 3:1) to form a petroleum-in-water emulsion and remove emulsion from soil to lower the total petroleum hydrocarbons in the soil to 1,000 mg/Kg or less.

In accordance with one embodiment of the present disclosure, includes a rinsing or drip washing the soil to form a petroleum-in-water emulsion, and than the petroleum-in-water emulsion can be removed from the soil through water.

The rinsing treatment is through adding water and mixing with the petroleum-contained soil to emulsify the remained petroleum hydrocarbons, and then put it aside to separate soil and the petroleum-in-water emulsion to facilitate removal of the petroleum-in-water emulsion.

The drip washing treatment is through adding water and mixing with the petroleum-contained soil to emulsify the remained petroleum hydrocarbons, and then wash away to remove the petroleum-in-water emulsion.

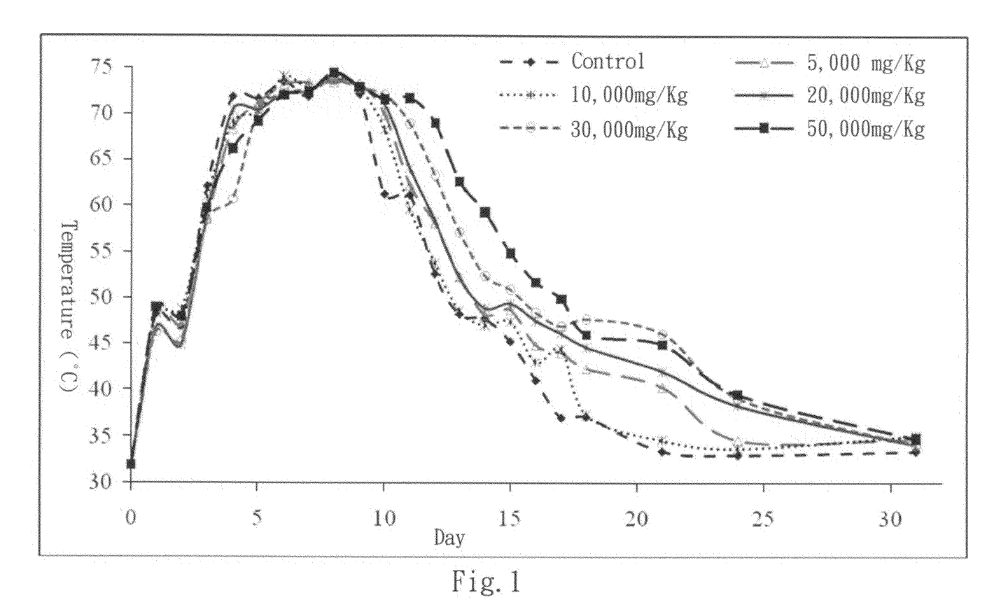

FIG. 1 shows the relationship between the temperature changes and the treatment days of various initial total petroleum hydrocarbons (TPH) dry basis concentration in the system. From FIG. 1, maximum tolerated concentration of petroleum hydrocarbons pollution with biodiversity system characteristics can be obtained. According to NIEA S730.61B of Taiwan Environmental Analysis Laboratory for sample soil concentration calculation, the data of TPH presents dry basis concentration. The dry basis concentration is calculated as follows:

TPH (dry basis concentration, mg/kg)=TPH Weight (mg)/[Key Matrix Fresh Weight (kg)−Key Matrix Water Weight (kg)]

As shown in FIG. 1, the tested petroleum hydrocarbons concentrations are of 0, 5,000, 10,000, 20,000, 30,000, 50,000 mg/kg, respectively. The system temperature is used as an indicator to index a normal evolution progress of the treatment processes. The results show that when the petroleum hydrocarbons pollution concentration ranged from 5,000-50,000 mg/kg, the systems stayed relatively consistent and the overall stability of the system was not affected. It indicates that coordinating of the biodiversity system with the microbial diversity characteristics and the key matrix of the presented disclosure can achieve highly reproducible result, degrade petroleum hydrocarbons with natural evolution in the biodiversity system.

Note that when the simulated diesel contamination is up to 50,000 mg/kg, the biological evolution of the system still stays normal. The phenomenon is indicates the contaminated soil treatment of the present disclosure is a high performance treatment.

However, when higher concentrations of diesel were added, system has slightly delayed 1 to 2 days to reach the high temperature phase and 1 to 3 days of high temperature and maturity phase with rising diesel concentration were extend.

These results also show that the biodiversity system of the present disclosure cab be used to degrade petroleum hydrocarbons on soil, and the increased diesel concentration on soil did not inhibit or retard the biological activity and the ability of petroleum hydrocarbons degradation of the system. This proves that the complementarily adaption to the environment of the microbial community is developed by the genetic diversity in the biodiversity system of the present disclosure, can solve the problems of conventional bioremediation approaches by adding single microbial strain or inorganic nutrients source, where the performance is suppressed by maximum tolerance concentration due to the unadapted of microbial strain in the contaminated sites.

According to FIG. 1, when the diesel pollution concentration gradually increased, the removal efficiency (the 31^{th} day) has respectively decreased: 5,000 (91%), 10,000 (86%), 20,000 (85%), 30,000 (73%), 50,000 (68%) mg/kg. It should be noted that the data shows above are collected at the 31^{th} day, the continuously degradation are progressed.

Therefore, the presented disclosure further proposes to ensure the normal operation of the system and a key matrix composition ability to degrade petroleum hydrocarbons to achieve reproducible results.

### (I) EFFECTING OF COMPOSITION OF THE KEY MATRIX

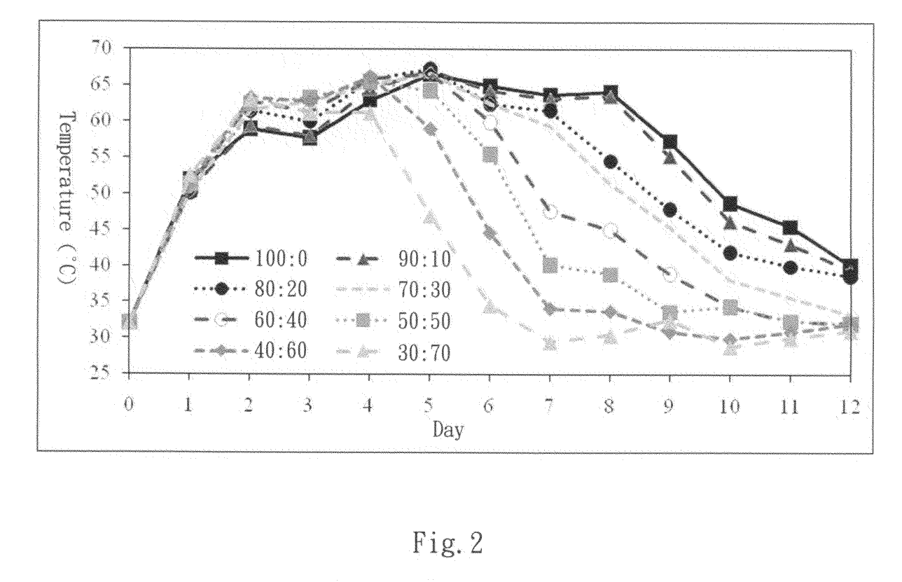

FIG. 2 shows the ratio of the compostable mixture and soil of the key matrix. In which, organic material and soil ratios are 10/0, 9/1, 8/2, 7/3, 6/4, 5/5, 4/6, 3/7.

The recycled materials were used as the source of organic materials in order to reduce costs and achieve the purpose of reuse of resources.

According to one embodiment, the sources of the compostable mixture (organic materials) are food wastes and wood chips and its C/N ratio is adjusted to the range of 10-20 as well as fatty acid content of compound is controlled at 0.5-10% by weight.

Food wastes were collected from Rui-Bing, Yu-Bing, Jin-Bing, Jin-Tian, Ren-Tian five areas in Kaohsiung City, Taiwan, and a few from families garbages and school lunch leftovers. Wood chips are from logs processing plants in Ziguan Township, Kaohsiung County.

The particle size of the compostable mixture is adjusted to approximately 1 cm or less, and the moisture content of organic material is controlled in the 50-70% range. After evenly mixing, the weight ratios of organic materials to soil are 100:0 (control pile), 90:10, 80:20, 70:30, 60:40, 50:50, 40:60, 30:70 various mixing ratios. The variations of composting temperature evolutions of the various mixing ratios were monitored and compared. The control pile (without adding soil) is referred to evaluate the impact of mixing ratio of soil and the compostable mixture in the biodiversity system.

Table 1 shows the matrix analysis of each pile with different the compostable mixture (organic materials) and soil mix ratio. The matrix of each pile is 100 kg, initial moisture content decreased as the proportion of soil increased, are controlled in 58, 53, 49, 47, 37, 32, 30, 22%.

TABLE 1
Different Ratios of Matrix

| Ratio of | | Matrix Analysis | | |
|---|---|---|---|---|
| Compostable | | Moisture | | |
| mixture and Soil | Total | Content | | EC |
| Weight | Weight (kg) | (%) | pH | (dS/m) |
| 10:0 | 100 | 58 | 4.66 | 3.02 |
| 9:1 | 100 | 53 | 4.52 | 2.27 |
| 8:2 | 100 | 49 | 4.73 | 2.12 |
| 7:3 | 100 | 47 | 4.57 | 2.42 |
| 6:4 | 100 | 37 | 4.73 | 1.53 |
| 5:5 | 100 | 32 | 4.67 | 1.73 |
| 4:6 | 100 | 30 | 4.63 | 1.83 |
| 3:7 | 100 | 22 | 5.06 | 1.07 |

During the experimental period of 12 days, it is mainly to observe the high temperature fermentation period of each pile. Along with temperature monitored, moisture content (%), electricity conductivity (EC) and pH value of the piles were also monitored daily.

In accordance with the embodiment of the presented disclosure, the dominant synergistic flora that can largely degrade petroleum hydrocarbons is with the best growth at temperature range of 50-75° C. In order to maintain the predominant growth of the synergistic flora to reproduce and metabolize degradation of petroleum hydrocarbons, an operative effort is needed to extend longer high temperature fermentation period to achieve better efficiency.

FIG. 2 shows temperature changes of different proportions of soil and organic material in the system for an increase over time. In the initial phase, temperatures of all the different ratios of matrix and soil rapidly increase. On day 1, the temperatures can all reach 50-52° C. On day 3 and day 2, the temperatures increase further to about 60° C. At this phases, the temperature seems positively relate to proportion of the soil. That is, the higher the proportion of soil added, the higher the temperature of the system; this phenomenon corresponds with lower moisture contents (see Table 1).

It is worthy noted that, on day 4, with 70% by weight soil (triangle dotted line), be the first one ends the high temperature fermentation phase and begins to cool down (only last for 3 days, the maximum temperature only reaches 63.1° C.); and the remaining proportion of the matrix continue to heating up with soil adding of 60%, 50%, 40%, 30%, 20%, 10% respectively return to the lower temperature after day 5 and day 6.

Results of FIG. 2 shows that when the soil proportion is high, due to less fatty acid compounds of the compostable mixture, results in shorter high temperature phase and not be able to provide environment for the synergistic flora to grow and metabolize; when the soil proportion is 0-30%, it can last for approximately 5-6 days of high temperature with above 70° C. (30% of soil ratio, the dotted line for the diamond-shaped), when the soil proportion increases to 40-70% by weight, it can last about 3-4 days to maintain the high temperature phase.

It's clearly that as higher proportion of soil added, the shorter the high temperature period, the sooner the temperature begin to return to lower temperature; on the other hand, the lower the proportion of soil added, the longer the high temperature maintained before returning to lower temperature. In general, under high temperature, the compostable mixture is degraded rapidly and petroleum hydrocarbons degraded microorganisms are active. Therefore, a longer phase of high temperature benefits contaminants degradation. As the result, proportion of soil added has its limits when applying this technology. In accordance with the results of the presented disclosure, the key matrix contains 60-70% of organic material weight ratio and 30-40% of soil weight ratio to create a well biodiversity environment and maintain predomination growth of petroleum hydrocarbons degrading synergistic flora.

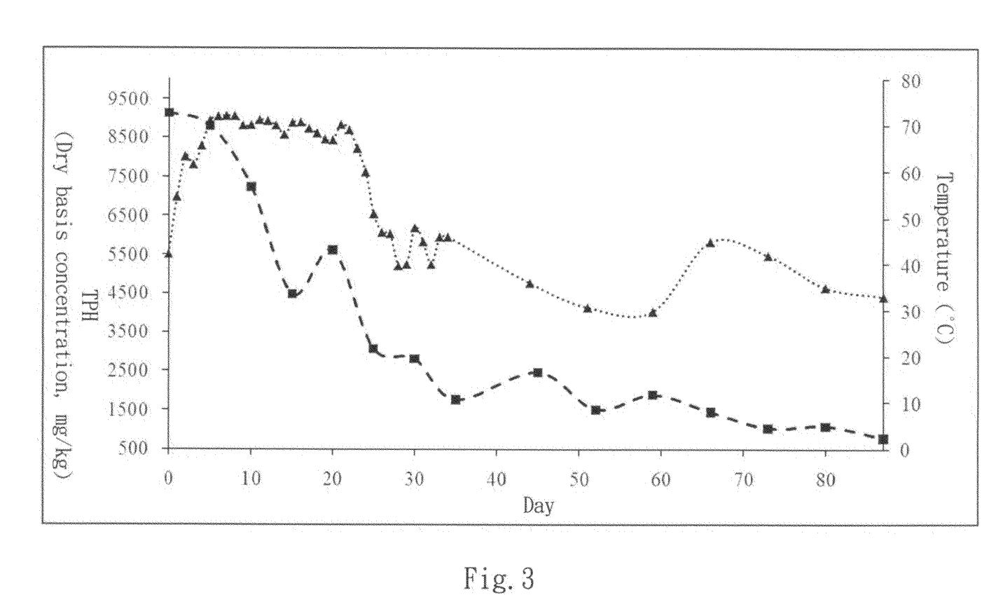

FIG. 3 shows the trial temperature and TPH concentration trends when degrading petroleum hydrocarbons in soil in a large scale trial (3000 kg with 30% of diesel contaminated soil) with the presented disclosure of the biodiversity system. In which, the triangle labeled curve is the temperature variation trend and the square labeled curve is the petroleum hydrocarbons concentration trend. It can be seen, on the 87^{th} day, more than 90% of diesel were degraded.

As can be seen from FIG. 3, when the system temperature increases and lasts about 12-14 days, high temperature phase is more than doubled as compared to the small scale trials in FIG. 2 (ratio of the compostable mixture and soil is 6-7:3-4, 50-75° C., lasts for about 6-7 days); and the results are consistent as what is shown in FIG. 2 with the evolution of the temperature change process in the small model trial. This result confirms the conversions for small scale trials to large scale trials and shows the high consistency (reproducibility) after conversions, and which also highlight the biodiversity system supported by composing different ratios of the key matrix. It can indeed use the environment and the complexity of bacterial gene interaction, through the evolution of bacterial community to develop and metabolize for the key matrix functions, to have the ability to degrade petroleum hydrocarbons, or a tendency to produce the key matrix predominated microorganism community and promote biodiversity system to generate reproducible results, and also using this technique to show feasibility of petroleum hydrocarbons-contaminated soil treatments.

According to the embodiment, by having the biodiversity system characteristics in large scale of soil remediation results in meeting regulatory standards of less than 1,000 mg/kg after 87 days. Compared that to the traditional remediation technologies, it has greatly reduced the restoration time, but still needs about three months for remediation. Further to expedite the processing efficiency, the present disclosure proposes when the system temperature drops to 35-50° C., combine with water washing treatments to remove remained emulsified petroleum hydrocarbons and effective in achieving faster restoration on pollutants-contaminated sites as well meeting regulatory standards quickly and cost effectively.

### (II) EXAMPLE

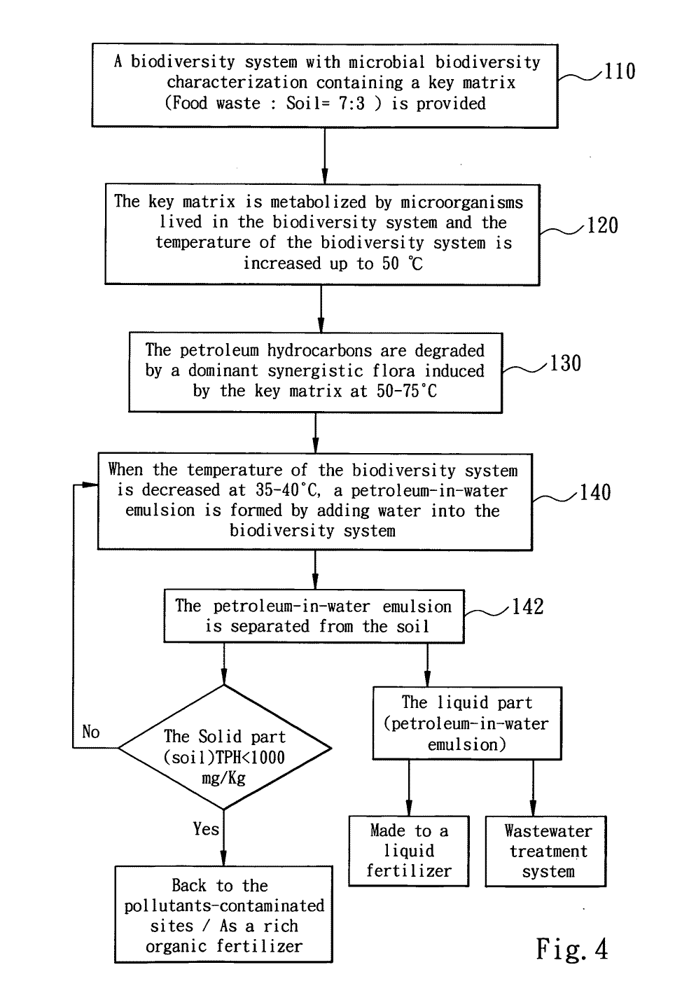

FIG. 4 is a flow chart for rapid steps to deal with pollutants-contaminated soil. As in step 110, firstly provide a compostable mixture and a key matrix contains pollutants-contaminated soil. The sources of compostable mixture are form recycled food waste, including raw food, cooked food, meat or fish and a variety of edible oils and fats and they can provide rich and diverse growth environment and nutritional source. It is very complicated to recycle food wastes originally and has to be bacterial characteristics; thus, the bio-system constructed by matrix using food wastes collected as the sources is in line with the embodiment required for biodiversity system characteristics.

The total weight of matrix is 100 kg, ratio of the compostable mixture and soil is 7:3, add 1 kilogram (1 liter) of diesel fuel to simulate 10,000 mg/kg (fresh weight basis concentration) of the initial value of petroleum hydrocarbons pollution. As sources of food waste as the compostable mixture itself is rich in water; therefore, the presented situation is fresh weight basis concentration, fresh weight basis moisture content is calculated as follows:

Moisture Content (%)=[Moisture Weight of Wet Object/Total Weight of Wet Object]×100%

In accordance with the embodiment, initial carbon and nitrogen ratio (C/N ration) of the compostable mixture (food waste) is about 10-20 and contains about 0.5-10% of the edible oils and fats by weight.

Term “Food Waste” described in this project especially means the one containing seasonings, cooking oil, animals or vegetable fat as household or restaurant raw food and cooked food waste mixture, covering the vegetarian and meat or fish materials.

In general, vegetarian (vegetables, fruits, etc.) is low in protein content, so the nitrogen (N) content is lower. Carbon and nitrogen ratio (C/N) is high. Meat or fish (chicken, duck, fish, shrimp, eggs, cattle, sheep, pigs, soy products, etc) provides proteins (and some animal fats), so nitrogen content is high (greater than 5%). Carbon and nitrogen ratio (C/N) is low. Nitrogen content affects bacteria composting and temperature changes. High nitrogen (low ratio of carbon and nitrogen) of raw materials with longer-term high temperature fermentation is the key capacity of degradation efficiency. The embodiment of the present disclosure use “food wastes” as composting material can provide lower initial C/N ratio compared with the more commonly used materials, such as wood chips, sugarcane wastes, rice straw and other plant materials.

In accordance with the embodiment of the present disclosure, the main sources of food wastes are from fruit and vegetable markets, family garbage and school lunch leftovers. Use the crushing machine to crush the recycled food wastes and adjust the particle size to less than 1 cm. As well, use dry materials (such as wood chips, spent nutrient package of mushroom cultivation, sugarcane wastes, hay, grass, rice bran, rice husk, rice straw, dry leaves or other organic materials) to adjust the C/N ratio of the initial composting mixture, and adjust the moisture content to be 50˜70 wt % to form the organic materials with microbial diversity. The addition of dry material can be 10-16 wt %, but not limited to this range.

Therefore, the key matrix to the embodiment does not only provide for bacterial utilization, but also it is a carrier of bacteria itself with microbial biodiversity characterization. In addition, the different materials obtained from different source of soils or the compostable mixture, and matrix mixing ratio, etc, also creates the biodiversity system of the present disclosure. According to the evolution of microorganism, it can expect the interaction between microorganism and the growth environment factors would tend to maintain the dynamic balancing state in the biodiversity system.

Step 120, when the biodiversity system has microbial biodiversity characterization, from the initial relatively stable environment of nutrition absorbed and reproduced, the key matrix of the embodiment based on the ratio of compostable mixture and soil is 7:3 to provide the key source of nutrition is relatively high; and furthermore, to provide fertile environment for microbial growth and metabolism.

Due to the environmental factors, diverse bacteria differentiation of the same species and genetic variation derive new strains, or in particular for those that are well-survived in environment to produce predominated strain. The phenomenon of increase or decrease of species causing by predominant bacteria community and more than one phenomenon of the above enrich the diversity characteristics of the biodiversity to active various bacteria grow at different phases. The large consumption of nutrients in key matrix increases system temperature. In the process, moisture content is controlled between 35-55 wt %.

When temperature rise to above 50° C., some bacteria have been unable to maintain normal metabolism, so with the limited food sources and extreme temperatures, the bacteria decline in the system.

As the energy transfers and temperature changes, the microorganisms, substances of derived from microorganisms metabolize nutrients, and the secondary metabolite of the substances can be nutrients for crops fertilizing, such as humus, or active biosurfactants as phospholipids, glycolipids and other metabolites.

Step 130, as shown in FIG. 2, the embodiment of the present disclosure constructs a biodiversity system. In the process of microbial metabolism, temperatures phases can be divided into heating up, high temperature, cooling down and stable. It shows that system is developing forward to the general process of composting.

In which, the biodiversity system with microbial biodiversity characterization of the compostable mixture (food wastes) may be induced by environmental factors to evolve a petroleum hydrocarbons degrading bacteria or a synergistic flora able to degrade the petroleum hydrocarbons. The synergistic flora metabolizes the petroleum hydrocarbons during the process of degrading edible oils and fats, and temperature range is between 50-75° C. for growth and metabolism. The relative long-chain petroleum hydrocarbons can be degrade into relatively short-chain compounds, or metabolize into fatty acids, esters, alcohols, aldehydes, or other carbon sources for bacteria to reduce total petroleum hydrocarbons in the soil.

In accordance with the embodiment of the present disclosure, a process of ventilation treatment with frequency of every 24 hours and the moisture are monitored the 35-55% to maintain the predomination growth of the dominant synergistic flora is processed.

According to the embodiment of the present disclosure, it can prove the use of the compostable mixture with microbial biodiversity characterization (such as food wastes and wood chips mixtures). As long as the critical proportions adjustment of the key matrix and specific nutrient content can naturally form the biodiversity characteristics to deliver the reproducibility in the system. No differences occurred when the non-critical nutrient sources differ, and do not need to add specific functional bacteria to achieve the desired effect. Instead, the use of the compostable mixture with biodiversity system characteristics, bacteria can evolve to develop the key matrix function. So the original bacteria naturally develop ability of key matrix metabolism or derive the predominated flora to adapt to the environment.

Table 2 shows distribution of bacteria in the system at different temperature phases.

TABLE 2
Distribution of Bacteria at Different Temperature (° C.) Phases

| | | 16S rDNA |
|---|---|---|
| Temperature (° C.) | Bacteria | Similarity |
| 30^{a} | Acinetobacter sp. | 99% |
| | Bacillus sp. (5) | 98%-99% |
| | Chryseobacterium sp. (2) | 99% |
| | Citrobacter sp. (2) | 99% |
| | Enterobacter sakazaki (2) | 99% |
| | Klebsiella pneumoniae subsp. | 99% |
| | Kurthia gibsonii (2) | 99% |
| | Lactobacillus sakei | 99% |
| | Morganella sp. (2) | 99% |
| | Providencia sp. | 99% |
| | Pseudomonas putida GB-1 | 99% |
| | Stenotrophomonas sp. | 99% |
| | Uncultured bacterium clone (4) | 99% |
| | Wautersiella faasenii subsp. | 99% |
| 55^{a} | Bacillus sp. (5) | 99% |
| | Cellulosimicrobium sp. | 99% |
| | Escherichia coli | 99% |
| | Low G + C Gram-positive bacterium | 99% |
| | Methylobacterium polarium | 99% |
| | Proteus mirabilis (5) | 99%-100% |
| | Uncultured bacterium clone | 99% |
| 70 | Bacillus sp. (6) | 99% |
| | Bacteroidetes bacterium | 99% |
| | Brevibacillus borstelensis | 99% |
| | Pseudoxanthomonas sp. (3) | 99% |
| | Shigella flexneri | 99% |
| | Uncultured bacterium clone (2) | 99% |
| | Ureibacillus sp. (2) | 99% |
| 55^{b} | Bacillus sp. (9) | 99% |
| | Low G + C Gram-positive bacterium | 99% |
| | Pseudoxanthomonas sp. | 99% |
| | Uncultured compost bacterium clone | 96% |
| 30^{b} | Acinetobacter sp. (2) | 99% |
| | Proteus mirabilis (2) | 99% |
| | Staphylococcus sp. (2) | 99% |

(^{a}indicates heating phase; ^{b}indicates cooling phase)

FIG. 2 shows that degradation of petroleum hydrocarbons in the soil by the small scale trial. The embodiment (ratio of compostable and soil is 7:3) has a biodiversity system characteristics, and microbial metabolism of key matrix at various phases of temperatures, such as 30° C., 55° C. of heating up phase, 70° C. of high temperature phase, and 55° C., 30° C. of the cooling down phase to isolate different bacteria in different phases. Among them, about 5 days to heat up to 70° C. and high temperature phase can lasts about a week, and then gradually cool down. In addition, Table 2 shows while at heating up phase, high temperature phase and cooling down phase within the temperature range of 50-75° C. can isolate a synergistic flora with function of degrading petroleum hydrocarbons in the thermophilic range. Thus, as shown in step 140, when the high temperature phase ends, physical treatments can be collaborated to remove the remained petroleum hydrocarbons in the soil compost. In a rinsing tank, mix the soil compost and water to ratio of 1:3, and biosurfactant occurs during the process of microbial metabolism can emulsify the remained petroleum hydrocarbons completely to form an emulsion.

Then, as shown in step 142, separate the soil and emulsion. As to put aside to separate soil and solid microbial metabolites from the emulsion to keep the emulsion with petroleum hydrocarbons stay in the water layer (liquid part), and separate the solid part. Then withdraw the liquid part to remove the remained petroleum hydrocarbons in the soil completely or to continue drip washing away the emulsion in the soil. In accordance with the embodiment, the liquid part can be made to a liquid fertilizer production systems to further aerated and fermented into liquid fertilizer, or led to existing wastewater treatment system and discharge after treatment. Solid part will be whether further rinsing or drip washing. If the total petroleum hydrocarbons of the solid part after one rinsing has not yet been reduced to 1,000 mg/Kg or less, apply further emulsified washing procedure to reduce to control standards of 1,000 mg/Kg or less. Then put back to the site (or act as a soil nutrient conditioner). The backfill soil has rich organic fertilizer.

Term “soil nutrient conditioner” means the treated soil thru biodiversity system and microbial metabolites, including soil and maturity compost materials. In which, they contain the minerals, trace elements, humus and other substances can be used for plant absorptions.

Although the present invention has been described in considerable detail with reference to certain embodiments thereof, other embodiments are possible. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for removing pollutants in pollutants-contaminated soil, comprising:
providing a biodiversity system with microbial biodiversity characterization, the biodiversity system comprises:
a key matrix can be metabolized by microorganisms lived in the biodiversity system, the key matrix containing 50-70% by weight of a compostable mixture and 30-50% by weight of a petroleum hydrocarbons-contained soil, wherein the compostable mixture containing 0.5-10% by weight of fatty acid, and the compostable mixture having a C/N ratio of 10-20;
a microorganism community with microbial biodiversity characterization, wherein the microorganism community metabolizes the key matrix and synthesizes at least one biosurfactant, at least one dominant synergistic flora is induced by the key matrix at 50-75° C. and the petroleum hydrocarbons are degraded by the dominant synergistic flora; and
adding water into the biodiversity system when the temperature of the biodiversity system is decreased at 35-50° C. to form a petroleum-in-water emulsion and separate the remained petroleum hydrocarbons from the soil, the amount of the petroleum hydrocarbons is reduced to 1,000 mg/Kg or less.

2. The method of claim 1, wherein the petroleum hydrocarbons-contained soil containing petroleum hydrocarbons with 6 to 40 carbon atoms chain, and the total petroleum hydrocarbons content is at least 1,000-50,000 mg/Kg.

3. The method of claim 1, wherein the fatty acid is CₙH₂ₙ₊₁COOH, CₘH₂ₘ₋ₓCOOH, CnH₂ₙ₊₁OH, or any combination thereof, wherein n=2-20, m=16-40, X is 1, 3, 5, 7, or any combination thereof.

4. The method of claim 1, further comprising at least one polymer of Cₙ(H₂O)ₙ₋₁, [(CH₂O)ₙ]ₓ, (C₆H₁₀O₅), polymer of C₁₂H₂₂O₁₀, or any combination thereof in the compostable mixture, wherein n=3-7, X=1-10.

5. The method of claim 1, further comprising at least one nitrogen compound with a general formula of R—CH₂—CH—NH₂—COOH, wherein R is —H, —CₙH₂ₙ₊₁ and n=1,2,3 or 4 integers, —C—[C₆H₅], —C—[C₆H₄]—OH, —C—[indole], —C-[imidazole], —CₙH₂ₙ₊₁COOH and n=1 or 2 integers, R′—NH₂ and R′ is —C₄H₉ or —COCH₂′—C₃H₇-[guanidine]′—CH₂OH′—C(OH)—C′—C₂H₅—S—CH₃—CH₂SH′—C—S—S—C′ imino acid, or any combination thereof.

6. The method of claim 1, wherein the compostable mixture is A material, B material, C material, or any combination thereof, wherein:
A is 0.5-10% by weight of the compostable mixture, comprising CₙH₂ₙ₊₁COOH, CₘH₂ₘ₋ₓCOOH, CnH₂ₙ₊₁OH, or any combination thereof, where n=2-20, m=16-40, X is 1, 3, 5, 7, or any combination thereof;
B comprises the polymer of Cₙ(H₂O)ₙ₋₁, [(CH₂O)ₙ]ₓ, (C₆H₁₀O₅), polymer of C₁₂H₂₂O₁₀, or any combination thereof in the compostable mixture, wherein n=3-7, X=1-10; and
C is a nitrogen compound with a general formula of R—CH₂—CH—NH₂—COOH, wherein R is —H, —CₙH₂ₙ₊₁ and n=1,2,3 or 4 integers, —C—[C₆H₅], —C—[C₆H₄]—OH, —C-[indole], —C-[imidazole], —CₙH₂ₙ₊₁COOH and n=1 or 2 integers, R′—NH₂ and R′ is —C₄H₉ or —COCH₂′—C₃H₇-[guanidine]′—CH₂OH′—C(OH)—C′—C₂H₅—S—CH₃′—CH₂SH′—C—S—S—C′ imino acid, or any combination thereof.

7. The method of claim 1, wherein the dominant synergistic flora is Bacillus sp., Bacteroidetes bacterium, Brevibacillus borstelensis, Pseudoxanthomonas sp., Shigella flexneri, Ureibacillus sp., Cellulosimicrobium sp., Escherichia coli, Methylobacterium polarium, Proteus mirabilis, Bacillus licheniformis, Low G+C Gram-positive bacterium (Guanin), Cytosine content Gram positive bacteria and any combination thereof.

8. The method of claim 1, wherein the biosurfactants are humic substances, glycolipids, phospholipids, or any combination thereof.

9. The method of claim 1, further comprising a ventilation treatment with frequency of every 18-30 hours to maintain the predomination growth of the dominant synergistic flora.

10. The method of claim 1, further comprising maintain 35-55 wt % of moisture of the biodiversity system.

11. The method of claim 1, wherein the method of forming the petroleum-in-water emulsion comprises:
adding water into the biodiversity system and rising to emulsify the remained petroleum hydrocarbons contained in soil to form the petroleum-in-water emulsion;
standing the petroleum-in-water emulsion to depose the soil and forming a two-layer stratified mixture contained a liquid layer and a soil layer;
separating the liquid layer from the two-layer stratified mixture to remove the remained petroleum hydrocarbons from the soil.

12. The method of claim 11, wherein the ratio of mixing the biodiversity system and water is 1:3.

13. The method of claim 11, further comprising aerating and fermenting the removed petroleum-in-water emulsion into a liquid fertilizer.

14. The method of claim 11, further comprising employing the soil separated from the petroleum-in-water as a soil nutrient conditioner.

15. The method of claim 1, wherein the method of forming the petroleum-in-water emulsion comprises:
adding and mixing water into the biodiversity system to emulsify the remained petroleum hydrocarbons contained in soil to form the petroleum-in-water emulsion; and
drip washing the petroleum-in-water emulsion to remove the petroleum-in-water emulsion from the soil.

16. The method of claim 15, wherein the ratio of mixing the biodiversity system and water is 1:3.

17. The method of claim 15, further comprising aerating and fermenting the petroleum-in-water emulsion removed from the soil into a liquid fertilizer.

18. The method of claim 15, further comprising employing the soil separated from the petroleum-in-water as a soil nutrient conditioner.

19. The method of claim 1, wherein the compostable mixture is cooked food wastes, or edible oil/fat-contained food wastes.
